(19) United States
(12) Patent Application Publication
(10) Pub. No.: US 2026/0270073 A1
(43) Pub. Date: Sep. 10, 2026

(54) SYSTEMS AND METHODS FOR SMART PREFETCHING

(71) Applicant: JPMORGAN CHASE BANK, N.A., New York, NY (US)

(72) Inventors: Gaurav MEHTA, Frisco, TX (US); Durai ARASAN, San Jose, CA (US); Sameer NAYAK, Fremont, CA (US); Monish UNNI, Mountain View, CA (US); Ravi KATTAMURI, Delaware, OH (US); Jason T. PENSHORN, Worthington, OH (US); Maqbul HUSSAIN, Woodland Park, NJ (US); Manjunath VENUGOPALA REDDY, Lewis Center, OH (US); Ravikumar DWIVEDI, New York, NY (US)

(21) Appl. No.: 19/467,432

(22) Filed: Feb. 2, 2026

Related U.S. Application Data
(60) Provisional application No. 63/753,094, filed on Feb. 3, 2025.

(51) Int. Cl. H04L 9/32; H04L 9/08

(52) U.S. Cl. CPC H04L 9/3234; H04L 9/0891

(57) ABSTRACT

In some embodiments, the techniques described herein relate to a method that may include: receiving, from an application executed by an electronic device and at a first server, a startup request indicating that the electronic device does not have a profile cached, wherein the startup request comprises unique device information, a token, and/or unique customer information; rate limiting, by the first server, the startup request among a plurality of startup requests; forwarding, by the first server to a second server, the startup request; extracting, by the second server, information comprising the unique device information, the token, and/or the unique customer information from the startup request by decrypting the information and validating the information; identifying and fetching, by the second server, data from a backend server; and returning, by the second server, an approval or rejection of the token to the application.

### RELATED APPLICATIONS

This application claims priority to, and the benefit of, U.S. Provisional Patent Application Ser. No. 63/753,094, filed Feb. 3, 2025, the disclosure of which is hereby incorporated, by reference in its entirety.

### BACKGROUND

### 1. Field of the Disclosure

Embodiments generally relate to systems and methods for secure application login and verification.

### 2. Description of the Related Art

Clients frequently log into applications by entering customer information such as usernames and passwords and, in some cases, biometric information including facial recognition or fingerprint scans. Two-factor authentication (2FA) may be used to strengthen account access, for example by requiring a one-time passcode delivered through SMS, email, or an authenticator application in addition to a primary credential. While these approaches are widely deployed, they remain susceptible to security lapses and operational inefficiencies. Bad actors may exploit credential stuffing, phishing, SIM-swap attacks, token replay, device spoofing, or social-engineering schemes to circumvent authentication gates or induce users to reveal secrets. Furthermore, the traditional login flow often introduces user experience friction: multiple network round-trips to validate credentials and retrieve profile data, variable latencies from backend services during peak periods, and repeated data fetches even for returning customers on known devices.

In many architectures, authentication and profile retrieval are strictly sequential, beginning only after the user initiates login, which may amplify perceived wait times. Edge cases such as device switching, stale sessions, or transient backend outages exacerbate delays and may lead to mismatched or partial data presentation. Additionally, performing all validation and profile assembly post-login concentrates load on upstream services, increasing the risk of congestion and degraded performance during traffic spikes or distributed denial-of-service events.

These systems may be improved by introducing a secure prefetch mechanism that operates prior to user credential entry. In one approach, an application may, upon startup, transmit a rate-limited request containing an encrypted token bound to a unique customer identifier. By anchoring decryption and token validation at the origin and enforcing strict policies that prevent data return prior to successful authentication, an improved prefetch architecture may harden the system against misuse while improving responsiveness for legitimate users.

Beyond performance gains, secure prefetching enhances resilience and correctness. In improved systems and methods, invalid or malformed tokens may be rejected early, preventing unnecessary backend calls and limiting attack surface. Further, key rotation may be centrally managed at the origin to maintain cryptographic hygiene. In some improved systems and methods, cache scoping and device-bound identifiers reduce the chance of data leakage when different users share a device; mismatches may trigger a fallback to normal backend fetches, preserving accuracy at the cost of temporary latency. Overall, the combination of edge rate limiting, origin-side cryptographic validation, and bounded caching yields a technical solution that increases security, reduces load on critical services, and delivers a faster, more reliable login experience.

### SUMMARY

Exemplary embodiments provide systems and methods for secure application login and verification. In some embodiments, the techniques described herein relate to a method that may include: receiving, from an application executed by an electronic device and at a first server, a startup request indicating that the electronic device does not have a profile cached, wherein the startup request comprises unique device information, a token, and/or unique customer information; rate limiting, by the first server, the startup request among a plurality of startup requests; forwarding, by the first server to a second server, the startup request; extracting, by the second server, information comprising the unique device information, the token, and/or the unique customer information from the startup request by decrypting the information and validating the information; identifying and fetching, by the second server, data from a backend server; returning, by the second server, an approval or rejection of the token to the application; allowing, by the second server, reception of user login information from the electronic device; validating, by the second server, the user login information; and allowing, by the second server and upon validation, an application programming interface (“API”) call with the unique customer identifier to the second server.

The method may include a secure, performance-optimized workflow for prefetching and serving customer profile data. A user device may send a startup request with unique device information and an encrypted token indicating no cached profile. A first server rate may limit the request among a plurality of requests and forward the request and/or a portion of the plurality of requests to a second server, which decrypts the token using a private key, may validate the request, and may extract a unique customer identifier. Using the unique customer identifier, the second server may fetch the customer's profile from a backend and caches the customer's profile locally for a bounded duration (e.g., about ten minutes), returning no profile data during prefetch.

After the user logs in, credentials may be validated to establish an authenticated session associated with the unique customer identifier. The application may issue an authenticated API call with the identifier. If a matching cached profile is available, the second server may serve the matching cached profile directly, reducing backend calls and latency; otherwise, the second server may fetch the profile from the backend and may update the cache. The method may include rejecting malformed or invalid tokens without contacting the backend, supporting private key rotation, enforcing policies preventing any data return before authentication, and/or handling identifier mismatches by bypassing cache to maintain correctness. Overall, the claims may implement layered edge rate limiting, origin-side cryptographic validation, short-lived caching, and strict policy controls to improve security, reliability, and user-perceived performance.

### BRIEF DESCRIPTION OF THE DRAWINGS

In order to facilitate a fuller understanding of the present disclosure, reference is now made to the attached drawings. The drawings should not be construed as limiting the present disclosure but are intended only to illustrate different embodiments and embodiments.

FIG. 1 is a block diagram of a system for secure application login and verification, in accordance with embodiments.

FIG. 2 is a method for secure application login and verification, in accordance with embodiments.

FIG. 3 is a block diagram of a computing device for implementing certain embodiments of the present disclosure.

### DETAILED DESCRIPTION

Embodiments generally relate to systems and methods for secure application login and verification.

Disclosed are systems and methods that may include receiving, from an application executed by an electronic device and at a first server, a startup request indicating that the electronic device does not have a profile cached. The first server may be a rate limiter. The first server may forward the startup request to a second server. Unique device information, a token, and/or unique customer information may be extracted from the startup request in an encryption. The token may be decrypted and/or validated by the second server. The unique customer information and/or unique device information may be extracted by the second server. The second server may identify and fetch data from a backend server. The second server may cache the data in a cache. The second server may return an approval or rejection of the token to the application.

Upon approval of the token, user login information may be transmitted from the electronic device to the second server. Once the credentials are validated, the user may be logged in. If authentication is successful, a unique customer identifier may be returned to the application. However, if authentication is unsuccessful, an error may be returned to the application. The application may send an application programming interface (“API”) call with the unique customer identifier to the second server. The second server may check the unique customer identifier against a cache of customer information. If the unique customer identifier is already stored, no action may be taken but if the unique customer identifier is not already stored, the second server may cache the unique customer identifier as well as related data (e.g., the unique device information, a number of times the token has been used, a time, a number of access attempts, a two-factor authentication approval or disapproval).

Disclosed systems and methods deliver concrete technical benefits by relocating and hardening profile validation within the API server and backend rather than relying on a rate limiting edge (e.g., provided by a content delivery network (“CDN”) and/or web application firewall (“WAF”)). When profile validation may not happen at the rate limiting/CDN layer, the disclosed architecture compensates with a layered, server-side validation and caching strategy that improves performance, resilience, and security.

By performing decryption of the token and validation of the unique customer identifier exclusively on the API server using private keys, the system eliminates the need to expose sensitive validation logic at the rate limiting server, reducing attack surface at the edge and preventing unauthorized requests from being processed downstream; failed decryptions are rejected immediately, avoiding unnecessary backend calls and minimizing risk from spoofed or malformed requests. Rate limiting at the edge combined with strict server-side gating ensures that even if the rate limiting server does not perform deep profile validation, the rate-limit control at the rate limiting server mitigates volumetric attacks while the API server's token verification and per-request gating provide semantic integrity checks, so the edge handles traffic shaping and the origin enforces authenticity.

Performance gains are achieved through prefetch and short-lived caching, as the system prefetches customer profile data pre-login and caches the customer profile locally at the API server for a bounded duration, enabling the app to retrieve the already cached profile post-authentication using the validated unique customer identifier, thereby reducing backend round-trips and shaving critical milliseconds off user-perceived load time, especially on cold starts or high-latency networks. Fault isolation and graceful degradation are maintained because origin-side validation guarantees correctness before data is served, and in edge cases where a different user logs in on the same device, the system detects identifier mismatches and falls back to a normal backend fetch so functionality continues without data leakage or corruption, with only performance impacted and not correctness. In some embodiments, the prefetch architecture may remove the time for application server and backend API communication, which may be a savings of around 500 milliseconds. This is significant when the login may take a total of 739 milliseconds in a traditional architecture, but around 239 milliseconds after the application server to backend API communication is removed.

Strong cryptographic control is supported with key rotation anchored at the API server, enabling controlled encryption key rotation without dependence on CDN validation features; keys may be rotated regularly to ensure forward security and minimize the blast radius of any key compromise while the decryption and validation pipeline remains consistent. Backend load is reduced through cache hits and rejection at the origin because requests that fail decryption at the API server are rejected and validated cache hits are served when possible, lowering infrastructure utilization, improving throughput under load, and enhancing scalability during peak usage. Consistent identity semantics and policy enforcement are achieved by centralizing validation and policy checks in the backend, ensuring uniform application of identity proofing rules, confirmation thresholds, device-bound checks, and risk scoring, which is difficult to maintain at the rate limiting server layer.

Users benefit from an improved experience with deterministic correctness through faster dashboard render times when cached profiles are available and accurate identity resolution, as the system guarantees that only profiles tied to a successfully authenticated, validated unique customer identifier are returned, reducing error states and misattributions. Collectively, these benefits demonstrate that even when profile validation may not happen at the rate limiting server layer, the server-side token decryption, origin-level validation, rate limiting, short-lived caching, and key rotation deliver superior security, reliability, performance, and scalability for identity-aware marketplace operations.

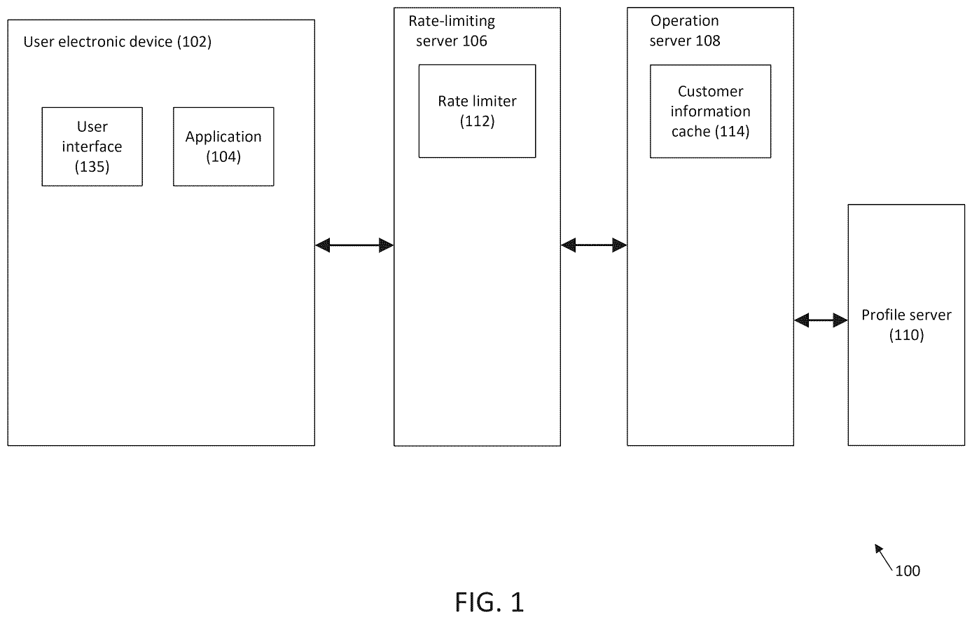

FIG. 1 is a block diagram of a system for secure application login and verification, in accordance with embodiments.

System 100 includes a user electronic device executing a marketplace application 104 available through a user interface 135, a rate-limiting server 106 and a server 108, each comprising a network or computer including a processor executing one or more software modules and a memory for storing data accessible by the one or more software modules and instructions to execute the one or more software modules. The rate-limiting server 106 may be a web application firewall and/or a content delivery network.

Server 108 may be an institution server that manages data flow to application 104. The server 108 may include one or more software modules executed by one or more processors as part of a cloud network or a local network. Server 108 may receive a pre-fetch profile from the application 104. Server 108 may load a customer profile onto a profile server 110 and verify the customer profile. Server 108 may cache information from the customer profile in a cache accessible by application 104. If the customer profile exists, server 108 may allow application 104 access to data managed by server 108 (e.g., customer financial account information, money transfer capability). If the customer profile does not exist, server 108 may block access based on the device information, require further verification, and/or require user information. Server 108 may further check customer profile information against server 110 to verify customer information.

Profile server 110 may be part of an institution backend. Profile server 110 may be part of a cloud-based server. Profile server 110 may be a computer. In some embodiments, profile server 110 may include one or more databases referenced by one or more of the software modules.

Application 104 may be allowed by server 108, once the pre-fetch process is complete, to enter login information including user login and password information, biometric information, and/or other login information (e.g., two-factor authentication). The login information may be used by profile server 110 to authenticate a session so that application 104 may access data manager by server 108.

Application 104 may execute an API call to server 108 to access data managed by server 108.

In accordance with some embodiments, user electronic device 102 may be a user electronic device such as a personal communication device (e.g., tablet, phone), computer workstation, laptop, or other electronic processing device in operative communication with application 104, server 106, and/or server 108. User electronic device 102 may be configured to interact with application 104 through user interface 135. For instance, user device 102 may include a client application that allows a user of user electronic device 102 to interact with application 104. User interface 135 may include one or more graphical user interfaces to receive inputs and/or display information to the user. User interface 135 and/or application 104 may comprise one or more instructions executed by one or more processors of user electronic device 102. Application 104 may be a software production application provided by a service organization. In an exemplary aspect, application 104 may be a financial institution application or system.

In operation, user electronic device 102 may execute application 104 and issues a startup request through user interface 135 wherein the startup request indicates that no profile is cached. The request may be directed to rate-limiting server 106, where rate limiter 112 throttles concurrent startup requests to mitigate burst traffic and potential abuse. The throttled request may be forwarded to operation server 108. Operation server 108 may decrypt the token contained in the request, validates the token, and extracts the unique customer identifier. If decryption or validation fails, operation server 108 may reject the request locally without invoking profile server 110, thereby preventing unnecessary upstream load. When validation succeeds, operation server 108 may fetch the customer profile from the backend and stores the customer profile in customer information cache 114 for a bounded duration, while returning no profile data to user electronic device 102 at this pre-login stage.

Upon user login, profile server 110 validates credentials and device signatures and establishes a session. Operation server 108 may interact with the profile server 110 to acquire a user's profile information. Application 104 may request the dashboard via user interface 135. Operation server 108 may check customer information cache 114 using the authenticated unique customer identifier. If a matching cache entry exists, operation server 108 may serve the profile directly from cache to the application 104, avoiding a backend call and reducing the time to render the dashboard on user electronic device 102. If the cache entry is absent or mismatched, for example, a different customer has logged in on the same device, operation server 108 may bypass cache 114 and retrieves the profile from the backend as business-as-usual, ensuring correctness. Throughout this flow, rate-limiting server 106 with rate limiter 112 may regulate request volume, while operation server 108 coordinates token validation, cache lifetime, and policy enforcement in conjunction with profile server 110, consistent with the architecture shown in FIG. 1.

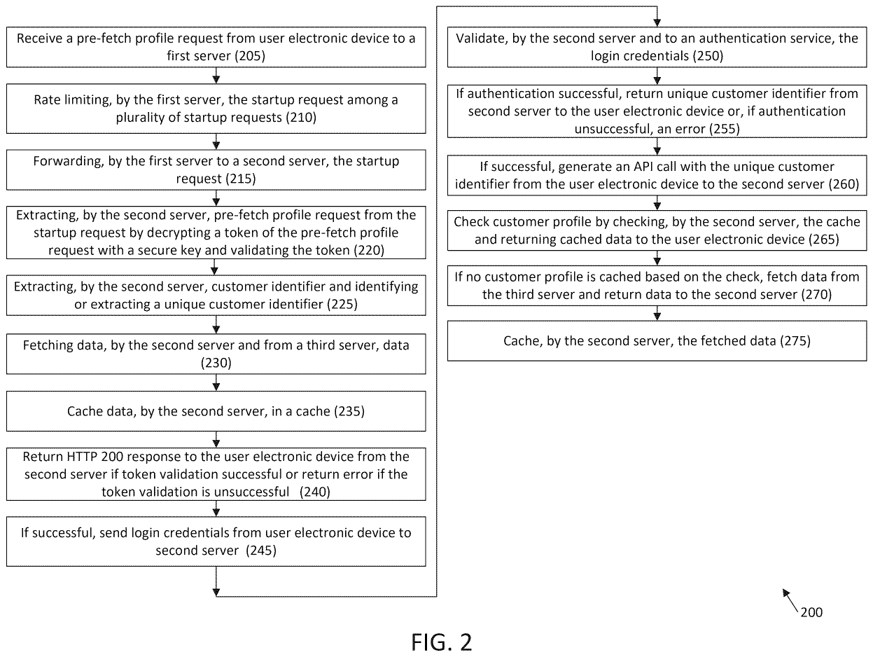

FIG. 2 is a method for secure application login and verification, in accordance with some embodiments. Method 200 may be stored as a list of instructions stored on a memory that when executed by one or more processors cause the one or more processors to perform the method.

Method 200 may include profile request handling that orchestrating a secure, performance-optimized prefetch and post-login retrieval of customer profile data. At 205, a user electronic device may transmit a prefetch profile request to a first server as the mobile application launches. This request may indicate that the device does not yet have a cached profile and includes unique device information and an encrypted token previously stored in a secure keychain on the device.

At 210, the first server may apply rate limiting to the incoming startup request among a plurality of concurrent startup requests. This edge control protects upstream systems from volumetric attacks and burst traffic, ensuring that only a bounded number of requests proceed in a given interval.

At 215, the first server may forward the startup request to a second server responsible for token processing and data orchestration.

At 220, the second server may extract the prefetch profile request from the startup request by decrypting the token using a secure, private key, and validating the token's integrity and freshness. If token validation fails, the second server may not proceed to backend calls; instead, the flow advances directly to 240 to return an error response to the user device.

If validation succeeds, the flow may continue to 225, where the second server may extract the customer identifier from the decrypted payload and identifies or derives a unique customer identifier that will serve as the canonical key for subsequent cache lookups and profile retrieval.

At 230, the second server may fetch the customer's profile data from a third server, which may be a financial backend or profile repository. The retrieved profile may include non-sensitive dashboard elements, preferences, basic account metadata, and other information permitted for rapid display post-authentication.

At 235, the second server may store the fetched data in a local cache with a bounded time-to-live, illustratively ten minutes. The cache is keyed by the unique customer identifier to enable rapid, authenticated retrieval later.

At 240, the second server may return an HTTP 200 response to the user electronic device if token validation was successful; no profile data is returned in this prefetch phase. If validation was unsuccessful, an error is returned to the device, and the flow does not populate the cache.

At 245, following a successful prefetch, the application may log in by sending login credentials from the user electronic device to the second server.

At 250, the second server may forward the credentials to an authentication service that validates the user's credentials and device signatures.

At 255, the authentication outcome may determine the next response: if authentication is successful, the second server returns the unique customer identifier to the user electronic device for authenticated API usage; if unsuccessful, an error may be returned and the method may terminate without exposing profile data.

At 260, upon successful authentication, the user electronic device may generate an API call containing the unique customer identifier to the second server to request the user dashboard.

At 265, the second server may check whether the customer profile is already cached by the second server. If the cache contains a profile keyed to the same unique customer identifier, the second server returns the cached data to the user electronic device, thereby saving a backend API call and reducing perceived load time.

If, at 270, no profile is cached for the current unique customer identifier, the second server may fetch profile data from the third server and returns this data to the second server for relay to the device.

At 275, the second server may cache the newly fetched data to accelerate subsequent dashboard requests within the cache lifetime.

In one example of a cold start with a valid token and matching user, a s an application may be launched on an electronic user device. The device may send a prefetch request with an encrypted token (205). The first server rate may limit concurrent startups (210) and forwards the request (215). The second server may successfully decrypt and validate the token (220), may extract the customer identifier, and may derive the unique customer identifier (225). The second server may fetch the profile from the backend (230) and cache the profile for ten minutes (235). The application may initiation a log in (245), and the authentication service may confirm credentials (250-255), returning the unique customer identifier to the device. The device may request the dashboard with the unique customer identifier (260). The second server may find a matching cache entry (265) and returns the cached profile immediately, shaving backend latency and improving time-to-first-view.

FIG. 2 thus demonstrates a secure, layered method design that may validate tokens at the origin, may prevent unnecessary backend calls on failures, may leverage short-lived caching to improve post-login responsiveness, and may enforce correctness when identities change, while the disclosed architecture may maintain resilience under heavy startup traffic via edge rate limiting.

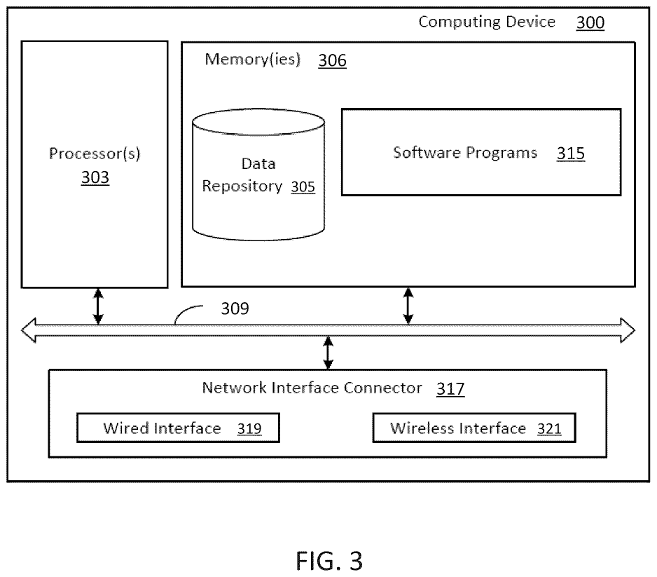

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which may be executed by processor 303. Memory 306 may include data repository 305, which may be nonvolatile memory for data persistence. The processor 303 and the memory 306 may be coupled by a bus 309. In some examples, the bus 309 may be coupled to one or more network interface connectors 317, such as wired network interface 319, and/or wireless network interface 321. Computing device 300 may have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the disclosure or portions of the system of the disclosure may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the disclosure may utilize a suitable operating system, and instructions may come directly or indirectly from the operating system.

The processing machine used to implement the disclosure may be a general-purpose computer. However, the processing machine described above may utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the disclosure.

It is appreciated that in order to practice the method of the disclosure as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the disclosure, be performed by a single component. Further, the processing performed by one distinct component as described above may be performed by two distinct components. In a similar manner, the memory storage performed by two distinct memory portions as described above may, in accordance with a further aspect of the disclosure, be performed by a single memory portion. Further, the memory storage performed by one distinct memory portion as described above may be performed by two memory portions.

Further, various technologies may be used to provide communication between the various processors and/or memories, as well as to allow the processors and/or the memories of the disclosure to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the disclosure. The set of instructions may be in the form of a program or software. The software may be in the form of system software or application software, for example. The software might be in the form of a collection of separate programs, a program module within a larger program, or a portion of a program module, for example. The software used might include modular programming in the form of object-oriented programming. The software tells the processing machine what to do with the data being processed.

Further, it is appreciated that the instructions or set of instructions used in the implementation and operation of the disclosure may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the disclosure. Rather, any number of different programming languages may be utilized as is necessary and/or desirable.

The instructions and/or data used in the practice of the disclosure may utilize any compression or encryption technique or algorithm, as may be desired. An encryption module might be used to encrypt data. Further, files or other data may be decrypted using a suitable decryption module, for example.

As described above, the disclosure may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might be contained on any of a wide variety of media or medium. That is, the particular medium, i.e., the memory in the processing machine, utilized to hold the set of instructions and/or the data used in the disclosure may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the disclosure may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the disclosure, a variety of “user interfaces” may be utilized to allow a user to interface with the processing machine or machines that are used to implement the disclosure. As used herein, a user interface includes any hardware, software, or combination of hardware and software used by the processing machine that allows a user to interact with the processing machine. A user interface may be in the form of a dialogue screen for example. A user interface may include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the disclosure, it is not necessary that a human user actually interact with a user interface used by the processing machine of the disclosure. Rather, it is contemplated that the user interface of the disclosure might interact, i.e., convey and receive information, with another processing machine, rather than a human user. Accordingly, the other processing machine might be characterized as a user. Further, it is contemplated that a user interface utilized in the system and method of the disclosure may interact partially with another processing machine or processing machines, while interacting partially with a human user.

It will be readily understood by those persons skilled in the art that the present disclosure is susceptible to broad utility and application. Many embodiments and adaptations of the present disclosure other than those herein described, as well as many variations, modifications, and equivalent arrangements, will be apparent from or reasonably suggested by the present disclosure and foregoing description thereof, without departing from the substance or scope of the disclosure.

In instances of this disclosure where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications, or equivalent arrangements.

1. A method comprising:
receiving, at a first server and from an application executed by a user electronic device, a startup request indicating that the user electronic device does not have a profile cached, the startup request comprising unique device information and an encrypted token;
rate limiting, by the first server, the startup request among a plurality of concurrent startup requests;
forwarding, by the first server, the startup request to a second server;
decrypting, by the second server, the encrypted token using a private key to extract a unique customer identifier and validating the encrypted token;
identifying, by the second server using the unique customer identifier, a customer profile and fetching the customer profile from a backend server;
caching, by the second server, the customer profile in a local cache keyed to the unique customer identifier for a bounded duration;
returning, by the second server, a response to the application without including the customer profile;
receiving, by the second server, user login information from the user electronic device;
validating, by an authentication service in operative communication with the second server, the user login information to establish an authenticated session associated with the unique customer identifier; and
serving, by the second server and responsive to an authenticated application programming interface (API) call containing the unique customer identifier, the customer profile from the local cache when available and matching the customer profile from the backend server.

2. The method of claim 1, wherein the bounded duration of the local cache is approximately ten minutes and the second server evicts the cached customer profile upon expiration of the bounded duration.

3. The method of claim 1, wherein the first server applies rate limiting at a content delivery network (CDN) edge service to mitigate volumetric attacks prior to forwarding the startup request to the second server.

4. The method of claim 1, further comprising rejecting, by the second server, the startup request without contacting the backend server when decrypting the encrypted token fails or validation of the encrypted token is unsuccessful.

5. The method of claim 1, further comprising rotating, by the second server, the private key used to decrypt the encrypted token according to a key rotation policy without interrupting the caching and serving of the customer profile.

6. The method of claim 1, wherein the unique customer identifier is device-bound and determined based at least in part on one or more device attributes comprising an operating system signature, device type, IP address, or device identifier.

7. The method of claim 1, further comprising, upon detecting that the unique customer identifier for the authenticated session does not match a cached entry, bypassing, by the second server, the local cache and performing a backend fetch to retrieve the customer profile while preventing any return of mismatched cached data.

8. A system comprising:
one or more processors; and
one or more memories storing instructions that, when executed by the one or more processors, cause the system to:
receive a startup request from an application executed by a user electronic device, the startup request indicating no cached profile for the user electronic device and comprising unique device information and an encrypted token;
apply rate limiting to the startup request among a plurality of concurrent startup requests; forward the startup request to an origin service;
decrypt the encrypted token using a private key to extract a unique customer identifier and validate the encrypted token;
identify and fetch, using the unique customer identifier, customer profile data from a backend server;
store the customer profile data in a local cache for a bounded duration keyed to the unique customer identifier;
return a response to the application without including the customer profile data;
receive user login information and validate the user login information to establish an authenticated session associated with the unique customer identifier; and
responsive to an authenticated API call containing the unique customer identifier, return the customer profile data from the local cache when available and performing a backend fetch to obtain and return the customer profile data.

9. The system of claim 8, wherein the rate limiting is performed at a CDN edge and the decrypting and validation are performed at the origin service to maintain semantic integrity of the startup request.

10. The system of claim 8, wherein the instructions further cause the system to reject the startup request at the origin service without initiating a backend fetch when decrypting the encrypted token fails or validation of the encrypted token is unsuccessful.

11. The system of claim 8, wherein the one or more memories store a key management module configured to rotate the private key used for token decryption on a regular schedule, and the origin service validates tokens using current keys while supporting graceful rollover.

12. The system of claim 8, further comprising a policy engine configured to enforce cache lifetime, device-bound identifier matching, and data return constraints preventing any customer profile from being transmitted prior to successful authentication.

13. The system of claim 8, wherein the local cache is configured to evict entries upon expiration or upon detection of identifier mismatch and to record cache hits and misses to reduce backend load under peak traffic conditions.

14. The system of claim 8, further comprising an identity proofing service in operative communication with the backend server and configured to verify a recipient identity by one or more techniques comprising document verification, liveness detection, and face comparison, and to store a verified recipient identity for reuse in subsequent transactions.

15. A non-transitory computer-readable storage medium storing instructions that, when executed by one or more processors, cause the one or more processors to perform operations comprising:
receiving, from an application executed by a user electronic device, a startup request indicating that the user electronic device lacks a cached profile in a cache, the startup request comprising unique device information and an encrypted token;
applying rate limiting to the startup request among a plurality of concurrent startup requests;
forwarding the startup request to a token processing service;
decrypting the encrypted token using a private key to extract a unique customer identifier and validating the encrypted token;
fetching customer profile data from a backend server using the unique customer identifier;
caching the customer profile data for a bounded duration keyed to the unique customer identifier;
returning a response to the application without including the customer profile data;
validating user login information to establish an authenticated session; and
upon receiving an authenticated API call containing the unique customer identifier, returning the cached customer profile data when available and matching, or otherwise fetching the customer profile data from the backend server and updating the cache.

16. The non-transitory computer-readable storage medium of claim 15, wherein the operations further comprise rejecting the startup request without a backend fetch upon decryption or validation failure and logging the rejecting to a security audit store.

17. The non-transitory computer-readable storage medium of claim 15, wherein the bounded duration of the cache is approximately ten minutes and the operations further comprise evicting cached entries upon expiration and invalidating cached entries upon detection of identifier mismatch.

18. The non-transitory computer-readable storage medium of claim 15, wherein the unique customer identifier is derived from the encrypted token and is bound to device attributes comprising an operating system signature, device type, IP address, or device identifier to mitigate misuse.

19. The non-transitory computer-readable storage medium of claim 15, wherein the operations further comprise enforcing a policy that prevents any customer profile data from being returned to the application prior to successful authentication and device-bound identifier validation.

20. The non-transitory computer-readable storage medium of claim 15, wherein the operations further comprise recording metrics of cache hits, cache misses, and rejected startup requests to dynamically adjust rate limiting thresholds and backend concurrency limits during high-traffic events.
